(19) United States
(12) Patent Application Publication
(10) Pub. No.: US 2017/0221302 A1
(43) Pub. Date: Aug. 3, 2017

(54) MULTISESSION HYBRID GAMES

(71) Applicant: Gamblit Gaming, LLC, Glendale, CA (US)

(72) Inventors: Miles Arnone, Sherborn, MA (US); Caitlyn Ross, Watertown, MA (US)

(21) Appl. No.: 15/491,617

(22) Filed: Apr. 19, 2017

Related U.S. Application Data
(63) Continuation of application No. 14/179,487, filed on Feb. 12, 2014.
Application No. 14/179,487 is a continuation of application No. PCT/US13/26557, filed on Feb. 17, 2013.
(60) Provisional application No. 61/600,177, filed on Feb. 17, 2012.

(51) Int. Cl. G07F 17/32

(52) U.S. Cl. CPC G07F 17/3227; G07F 17/3223; G07F 17/3288; G07F 17/3239

(57) ABSTRACT

An electromechanical gaming machine for providing a multisession hybrid game containing a gambling game providing a game of chance and an entertainment game providing a game of skill, where the entertainment game utilizes a multisession module constructed to: load game state data from a database accessible to the multisession module, where game state data is information from a prior entertainment game gameplay session associated with a player and capable of being utilized to configure an entertainment game gameplay session; initiate a current entertainment game gameplay session for the player using the game state data retrieved by the multisession module, where the current entertainment game gameplay session builds upon the player's interactions with the multisession hybrid game in the prior entertainment game gameplay session; and store game state data in the database based upon information concerning the current entertainment game gameplay session associated with the player.

### CROSS REFERENCE TO RELATED APPLICATIONS

This application is a continuation of U.S. patent application Ser. No. 14/179,487, filed Feb. 12, 2014, which is a continuation of Patent Cooperation Treaty Application No. PCT/US13/26557, filed on Feb. 17, 2013, which claims the benefit of U.S. Provisional Patent Application No. 61/600,177 filed on Feb. 17, 2012, the contents of each of which are hereby incorporated by reference as if stated in full herein. This application references U.S. Provisional Patent Application Nos. 61/572,135, filed Jul. 12, 2011, and 61/629,018, filed Nov. 10, 2011, and Patent Cooperation Treaty Application Nos. PCT/US12/46441, filed Jul. 12, 2012, PCT/US11/26768, filed Mar. 1, 2011, PCT/US11/63587, filed Dec. 6, 2011, and PCT/US12/58156, filed Sep. 29, 2012, the contents of each of which are hereby incorporated by reference as if stated in full herein.

### FIELD OF THE INVENTION

Embodiments of the present invention are generally related to gaming and more specifically to a multisession hybrid game that includes both an entertainment game and a gambling game capable of providing a continuous player gameplay experience across multiple gameplay sessions.

### BACKGROUND

The gaming machine manufacturing industry has traditionally developed gaming machines with a gambling game. A gambling game is typically a game of chance, which is a game where the outcome of the game is generally dependent solely on chance (such as a slot machine). A game of chance can be contrasted with a game of skill where the outcome of the game may depend upon a player's skill with the game. Gambling games are typically not as interactive and do not include graphics as sophisticated as an entertainment game, which is a game of skill such as a video game.

### SUMMARY OF THE INVENTION

Systems in accordance with embodiments of the invention operate a multisession hybrid game. One embodiment includes an electromechanical gaming machine providing a multisession hybrid game, including: a real world controller constructed to provide a randomly generated payout of real world credits from a wager in a gambling game; an entertainment software controller constructed to execute an entertainment game providing outcomes based upon skillful execution of the entertainment game to earn a payout of game world credits; and a game world controller constructed to manage the entertainment software controller and communicate gameplay gambling event occurrences based upon skillful execution of the entertainment game that trigger at least one wager in the gambling game to the gambling game; where the game world controller utilizes a multisession module constructed to: load game state data from a database accessible to the multisession module, where game state data is information from a prior entertainment game gameplay session associated with a player and capable of being utilized to configure an entertainment game gameplay session; initiate a current entertainment game gameplay session for the player using the game state data retrieved by the multisession module, where the current entertainment game gameplay session builds upon the player's interactions with the multisession hybrid game in the prior entertainment game gameplay session; and store game state data in the database based upon information concerning the current entertainment game gameplay session associated with the player.

In a further embodiment, the multisession module is constructed to load game state data from a database by utilizing a game state data identifier, where the game state data identifier is a code that identifies game state data in a database.

In another embodiment, the game state data identifier is utilized upon detection of biometric information.

In a still further embodiment, the multisession module is constructed to load game state data from a player profile.

In still another embodiment, the game state data is data selected from the group consisting of: a player's nickname, rating for skill at the entertainment game, preferences for a gameplay session, entertainment game theme preferences, a last game level achieved at an entertainment game, accumulation of game world credits, a preferred starting point in an entertainment game, a selected avatar, sound volume, wager term preferences, elements accrued, and real world credits used in a gambling game.

In a yet further embodiment, the game state data is loaded from a location accessible to the multisession hybrid game via a network.

In yet another embodiment, the game state data is loaded from a remote server and copied from memory located in the remote server to the multisession hybrid game.

In a further embodiment again, the game state data is loaded from a second multisession hybrid game.

In another embodiment again, the current entertainment game gameplay session is executed by the entertainment software controller.

In a further additional embodiment, the information concerning the current entertainment game gameplay session is received by the multisession module from the entertainment software controller.

In another additional embodiment, the multisession module initiates a current entertainment game gameplay session by communicating the game state data loaded by the multisession module to the entertainment software controller.

In a still yet further embodiment, a player of a multisession hybrid game is an electronic representation of interactions associated with a player profile of the multisession hybrid game.

In still yet another embodiment, the multisession module is constructed to execute on the game world controller.

In a still further embodiment again, the multisession module is constructed to execute on a multisession server and communicate with the game world controller via a network.

In still another embodiment again, the game state data is generated by the multisession module.

A still further additional embodiment includes a method of operating a multisession hybrid game, the method including: loading game state data from a database, where game state data is information from a prior entertainment game gameplay session associated with a player and capable of being utilized to configure an entertainment game gameplay session using a multisession module utilized by a game world controller, where: the game world controller is constructed to manage an entertainment software controller and communicate gameplay gambling event occurrences based upon skillful execution of an entertainment game that trigger at least one wager in a gambling game to a gambling game executed by a real world controller; the entertainment software controller constructed to execute an entertainment game providing outcomes based upon skillful execution of the entertainment game to earn a payout of game world credits; and the real world controller is constructed to provide a randomly generated payout of real world credits from a wager in a gambling game; initiating a current entertainment game gameplay session for the player using the game state data retrieved by the multisession module, where the current entertainment game gameplay session builds upon the player's interactions with the multisession hybrid game in the prior entertainment game gameplay session; and storing game state data in the database based upon information concerning the current entertainment game gameplay session associated with the player.

In still another additional embodiment, the multisession module is constructed to load game state data from a database by utilizing a game state data identifier, where the game state data identifier is a code that identifies game state data in a database.

In a yet further embodiment again, the game state data identifier is utilized upon detection of biometric information.

In yet another embodiment again, the game state data is data selected from the group consisting of: a player's nickname, rating for skill at the entertainment game, preferences for an gameplay session, entertainment game theme preferences, a last game level achieved at an entertainment game, accumulation of game world credits, a preferred starting point in an entertainment game, a selected avatar, sound volume, wager term preferences, elements accrued, and real world credits used in a gambling game.

A yet further additional embodiment includes a machine readable medium containing processor instructions, where execution of the instructions by a processor causes the processor to perform a process including: loading game state data from a database, where game state data is information from a prior entertainment game gameplay session of a multisession hybrid game associated with a player and capable of being utilized to configure an entertainment game gameplay session using a multisession module utilized by a game world controller, where: the game world controller is constructed to manage an entertainment software controller and communicate gameplay gambling event occurrences based upon skillful execution of an entertainment game that trigger at least one wager in a gambling game to a gambling game executed by a real world controller; the entertainment software controller constructed to execute an entertainment game providing outcomes based upon skillful execution of the entertainment game to earn a payout of game world credits; and the real world controller is constructed to provide a randomly generated payout of real world credits from a wager in a gambling game; initiating a current entertainment game gameplay session for the player using the game state data retrieved by the multisession module, where the current entertainment game gameplay session builds upon the player's interactions with the multisession hybrid game in the prior entertainment game gameplay session; and storing game state data in the database based upon information concerning the current entertainment game gameplay session associated with the player.

### BRIEF DESCRIPTION OF THE DRAWINGS

FIG. 1 illustrates a multisession hybrid game in accordance with an embodiment of the invention.

FIG. 2 is a conceptual diagram that illustrates how resources are utilized in a multisession hybrid game in accordance with an embodiment of the invention.

FIG. 3 is a conceptual diagram that illustrates interplay between resources and components of a multisession hybrid game in accordance with an embodiment of the invention.

FIG. 4 is a timing diagram that illustrates a process of facilitating interactions between an entertainment game and a gambling game in accordance with embodiments of the invention.

FIG. 5 is a system diagram that illustrates a network distributed multisession hybrid game in accordance with an embodiment of the invention.

FIG. 6 is a system diagram that illustrates an implementation of a network distributed multisession hybrid game with a game world engine local server in accordance with an embodiment of the invention.

FIG. 7 is a system diagram that illustrates an implementation of a network distributed hybrid game with a game world engine group server in accordance with an embodiment of the invention.

FIG. 8 is a system diagram that illustrates an implementation of an Internet distributed hybrid game in accordance with an embodiment of the invention.

FIG. 9 illustrates a flow chart of a process of executing a multisession hybrid game gameplay session in accordance with an embodiment of the invention.

FIG. 10 illustrates a flow chart of a process of executing a multisession hybrid game gameplay session utilizing host mode in accordance with an embodiment of the invention.

FIG. 11 illustrates a flow chart of a process of executing a multisession hybrid game gameplay session using a game state data identifier in accordance with an embodiment of the invention.

FIG. 12 illustrates a hardware architecture diagram of a processing apparatus utilized in the implementation of a multisession hybrid game in accordance with an embodiment of the invention.

### DETAILED DESCRIPTION

Turning now to the drawings, systems and methods for operation of a multisession hybrid game are illustrated. In several embodiments, a multisession hybrid game is a form of a hybrid game that integrates a multisession module with both a gambling game that includes a real world engine (RWE) which manages the gambling game, as well as an entertainment game that includes a game world engine (GWE) which manages the entertainment portion of a game, and an entertainment software engine (ESE) which executes the entertainment game for user entertainment. In certain embodiments, the multisession hybrid game also includes a user interface associated with either or both the gambling game and the entertainment game. A player of a multisession hybrid game is the electronic representation of interactions, typically via a user interface, associated with a player profile of the multisession hybrid game. In operation of a multisession hybrid game, a player acts upon various types of elements of the entertainment game in a game world environment. Elements are a limited resource consumed within an entertainment game to advance entertainment game gameplay. In playing the entertainment game using the elements, a player can (optionally) consume and accrue game world credits (GWC) within the entertainment game. These credits can be in the form of (but are not limited to) game world objects, experience points, or points generally. Wagers are made in the gambling game using real world credits (RWC). The real world credits can be credits in an actual currency, or may be credits in a virtual currency which has real world value. Gambling outcomes from the gambling game may cause consumption, loss or accrual of RWC. In addition, gambling outcomes in the gambling game may influence elements in the entertainment game such as (but not limited to) by restoring a consumed element, causing the loss of an element, restoration or placement of a fixed element. In certain embodiments, elements can also be wagered in a gambling game for a payout of elements. Example elements include enabling elements (EE) which are elements that enable a player's play of the entertainment game and whose consumption by the player while playing the entertainment game may trigger a wager in a gambling game. Another example of an element are reserve enabling elements (REE), which are elements that convert into enabling elements upon occurrence of a release event in transportable variable hybrid game gameplay. Other types of elements include actionable elements (AE) which are elements that are acted upon to trigger a wager in the gambling game and may not be restorable during normal play of the entertainment game. In progressing through entertainment game gameplay, elements can be utilized by a player during interactions with a controlled entity (CE) which is a character, entity, inanimate object, device or other object under control of a player. Also, entertainment game gameplay progress can be dependent upon: a required object (RO) which is a specific object in an entertainment game necessary for an AE to be completed (such as but not limited to a specific key needed to open a door); a required environmental condition (REC) which is a game state necessary within an entertainment game for an AE to be completed (such as but not limited to daylight that is required to walk through woods); or a controlled entity characteristic (CEC) which is a status necessary of the CE within an entertainment game for an AE to be completed (such as but not limited to a CE required to have full health points before entering battle). Various hybrid games are discussed in Patent Cooperation Treaty Application No. PCT/US11/26768, filed Mar. 1, 2011, entitled ENRICHED GAME PLAY ENVIRONMENT (SINGLE and/or MULTIPLAYER) FOR CASINO APPLICATIONS and Patent Cooperation Treaty Application No. PCT/US11/63587, filed Dec. 6, 2011, entitled ENHANCED SLOT-MACHINE FOR CASINO APPLICATIONS each disclosure of which is hereby incorporated by reference in its entirety.

In many embodiments, a multisession hybrid game is a hybrid game with a multisession module constructed to enable continuous multisession entertainment game gameplay across multiple entertainment game gameplay sessions. The multisession module is configured to enable multisession entertainment game gameplay by initiating a current entertainment game gameplay session for a player that builds upon the player's interactions with a multisession hybrid game in a prior entertainment game gameplay session. Each entertainment game gameplay session can span the course of a player's interaction with a multisession hybrid game in a single session. The current entertainment game gameplay session is initiated using game state data saved in a database from a prior entertainment game gameplay session associated with the player. The current entertainment game gameplay session can also generate game state data that can be stored in a database and used in configuring future entertainment game gameplay sessions.

In several embodiments, game state data is information from an entertainment gameplay session that can be used to configure another entertainment game gameplay session. In several embodiments, game state data is loaded from and/or stored within a database. In certain embodiments, game state data is stored within a player's player profile stored within a database. The game state data can be loaded from a query of the game stage data using a game state data identifier that identifies the game state data in a database. The game state data identifier can be identifying characteristics unique to a player and/or an entertainment game gameplay session. In certain embodiments, a game state data identifier can be a code that can be stored electronically or printed on a physical medium. In particular embodiments, a game state identifier can be utilized upon a positive detection of biometric information (such as but not limited to a fingerprint, retinal scan, facial/image recognition or voice prints) that physically identifies a player. In several embodiments, the game state data can be any data capable of being utilized in configuring an entertainment game gameplay session including but not limited to a player's nickname, rating for skill at the entertainment game, preferences for the gameplay session, entertainment game theme preferences, a last game level achieved at the entertainment game, accumulation of game world credits, a preferred starting point in the entertainment game, a selected avatar, sound volume, wager term preferences, elements accrued, and real world credits used for wagering.

In several embodiments, game state data can be loaded from a remote server accessible to the multisession hybrid game over a network or stored locally on a multisession hybrid game. In certain embodiments, a server maintains a database of game state data accessible to multiple multisession hybrid games over a network. In other embodiments, each multisession hybrid game maintains a database of game state data locally that is accessible by the local multisession hybrid game or other remote multisession hybrid games over a network.

In numerous embodiments, a multisession module can be implemented locally on a multisession hybrid game within the GWE, remotely on a multisession server accessible to a multisession hybrid game via a network or as a distributed system where processes of a multisession module occur locally on a multisession hybrid game and on a remote server.

Multisession hybrid games in accordance with embodiments of the invention are discussed below.

### Multisession Hybrid Games

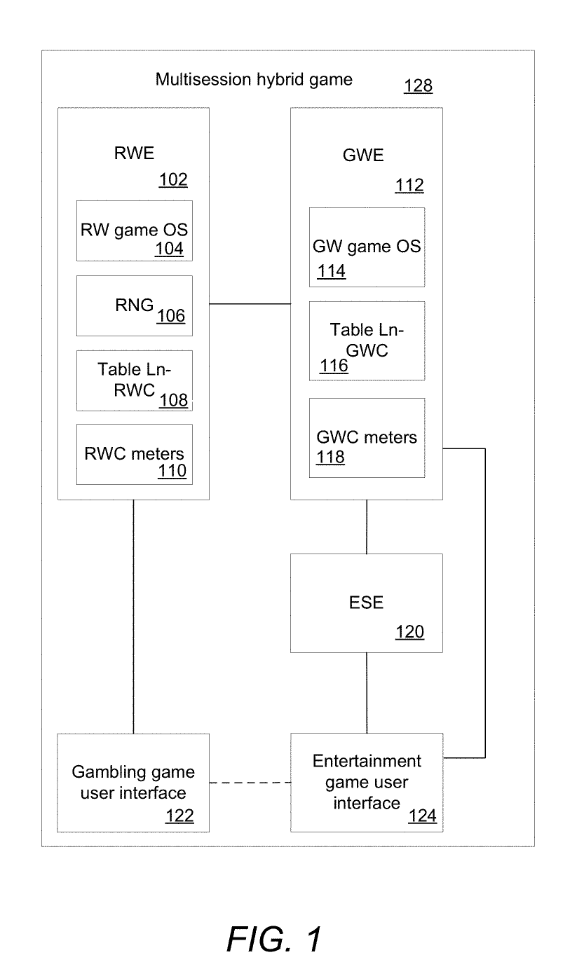

In many embodiments, a multisession hybrid game integrates high levels of entertainment content with a game of skill (entertainment game), a gambling experience with a game of chance (gambling game). A multisession hybrid game provides for random outcomes independent of player skill while providing that the user's gaming experience (as measured by obstacles/challenges encountered, time of play and other factors) is shaped by the player's skill. The multisession hybrid game can also utilize a multisession module to enable multisession entertainment game gameplay that is continuous across multiple gameplay sessions. The multisession module is configured to enable multisession entertainment game gameplay by initiating a current entertainment game gameplay session for a player that builds upon the player's interactions with a multisession hybrid game in a prior entertainment game gameplay session. A multisession hybrid game in accordance with an embodiment of the invention is illustrated in FIG. 1. The multisession hybrid game 128 includes a RWE 102, GWE 112, ESE 120, gambling game user interface 122 and entertainment game user interface 124. The two user interfaces may be part of the same user interface but are separate in the illustrated embodiment. The RWE 102 is connected with the GWE 112 and the gambling game user interface 122. The ESE 120 is connected with the GWE 112 and the entertainment game user interface 124. The GWE 112 is connected also with the entertainment game user interface 124.

In several embodiments, the RWE 102 is the operating system for the gambling game of the multisession hybrid game 128 and controls and operates the gambling game. The operation of a gambling game is enabled by RWC, such as money or other real world funds. A gambling game can increase or decreases an amount of RWC based on random gambling outcomes, where the gambling proposition of a gambling game is typically regulated by gaming control bodies. In many embodiments, the RWE 102 includes a RW operating system (OS) 104, random number generator (RNG) 106, level n real-world credit pay tables (Table Ln-RWC) 108, RWC meters 110 and other software constructs that enable a game of chance to offer a fair and transparent gambling proposition, and to contain the auditable systems and functions that can enable the game to obtain gaming regulatory body approval.

A random number generator (RNG) 106 includes software and/or hardware algorithms and/or processes, which are used to generate random outcomes. A level n real-world credit pay table (Table Ln-RWC) 108 is a table that can be used in conjunction with a random number generator (RNG) 106 to dictate the real world credits (RWC) earned as a function of sponsored gameplay and is analogous to the pay tables used in a conventional slot machine. Table Ln-RWC payouts are independent of player skill. There may be one or a plurality of Table Ln-RWC pay tables 108 contained in a gambling game, the selection of which may be determined by factors including (but not limited to) game progress a player has earned, and/or bonus rounds which a player may be eligible for. Real world credits (RWC) are credits analogous to slot machine game credits, which are entered into a gambling game by the user, either in the form of money such as hard currency or electronic funds. RWCs can be decremented or augmented based on the outcome of a random number generator according to the Table Ln-RWC real world credits pay table 108, independent of player skill. In certain embodiments, an amount of RWC can be required to enter higher ESE game levels. RWC can be carried forward to higher game levels or paid out if a cash out is opted for by a player. The amount of RWC required to enter a specific level of the game level n need not be the same for each level.

In many embodiments, the GWE 112 manages the overall multisession hybrid game operation, with the RWE 102 and the ESE 120 effectively being support units to the GWE 112. In several embodiments, the GWE 112 contains mechanical, electronic and software system for an entertainment game. The GWE 112 includes an operating system (OS) 114 that provides control of the entertainment game. The GWE additionally contains a level n game world credit pay table (Table Ln-GWC) 116 from where to take input from this table to affect the play of the entertainment game. The GWE 112 can further couple to the RWE 102 to determine the amount of RWC available on the game and other metrics of wagering on the gambling game (and potentially affect the amount of RWC in play on the RWE 102). The GWE 112 additionally contains various audit logs and activity meters (such as the GWC meter) 118. The GWE 112 can also couple to a centralized server for exchanging various data related to the player and their activities on the game. The GWE 112 furthermore couples to the ESE 120.

In many embodiments, a level n game world credit pay table (Table Ln-GWC) 116 dictates the GWC earned as a function of player skill in the nth level of the game. The payouts governed by this table are dependent upon player skill and sponsored gameplay at large and may or may not be coupled to a random number generator. In several embodiments, game world credits (GWC) are player points earned or depleted as a function of player skill, specifically as a function of player performance in the context of the game. GWC is analogous to the score in a typical video game. Each entertainment game has one or more scoring criterion, embedded within the Table Ln-GWC 116 that reflects player performance against the goal(s) of the game. GWC can be carried forward from one level of sponsored gameplay to another, and ultimately paid out in various manners such as directly in cash, or indirectly such as earning entrance into a sweepstakes drawing, or earning participation in, or victory in, a tournament with prizes. GWC may be stored on a player tracking card or in a network-based player tracking system, where the GWC is attributed to a specific player.

In certain embodiments, the operation of the GWE 112 does not affect the RWE's 102 gambling operation except for player choice parameters that are allowable in slot machines including but not limited to wager terms such as but not limited to a wager amount, how fast the player wants to play (by pressing a button or pulling the slot's handle) and/or agreement to wager into a bonus round. In this sense, the RWE 102 provides a fair and transparent, non-skill based gambling proposition co-processor to the GWE 112. In the illustrated embodiment, the communication link shown between the GWE 112 and the RWE 102 allows the GWE 112 to obtain information from the RWE 102 as to the amount of RWC available in the gambling game. The communication link can also convey a necessary status operation of the RWE (such as on-line or tilt). The communication link can further communicate the various gambling control factors which the RWE 102 uses as input, such as the number of RWC consumed per game or the player's election to enter a jackpot round. In FIG. 1, the GWE 112 is also shown as connecting to the player's user interface directly, as this may be necessary to communicate certain entertainment game club points, player status, control the selection of choices and messages which a player may find useful in order to adjust their entertainment game experience or understand their gambling status in the RWE 102.

In various embodiments, the ESE 120 manages and controls the visual, audio, and player control for the entertainment game. In certain embodiments, the ESE 120 accepts input from a player through a set of hand controls, and/or head, gesture, and/or eye tracking systems and outputs video, audio and/or other sensory output to a user interface. In many embodiments, the ESE 120 can exchange data with and accept control information from the GWE 112. In several embodiments an ESE 120 can be implemented using a personal computer (PC), a Sony PlayStation® (a video game console developed by Sony Computer Entertainment of Tokyo Japan), or Microsoft Xbox® (a video game console developed by Microsoft Corporation of Redmond, Wash.) running a specific entertainment game software program. In numerous embodiments, an ESE can be an electromechanical game system of a multisession hybrid game that is an electromechanical hybrid game. An electromechanical hybrid game executes an electromechanical game for player entertainment. The electromechanical game can be any game that utilizes both mechanical and electrical components, where the game operates as a combination of mechanical motions performed by at least one player or the electromechanical game itself. Various electromechanical hybrid games are discussed in Patent Cooperation Treaty Application No. PCT/US12/58156, filed Sep. 29, 2012, the contents of which are hereby incorporated by reference in their entirety.

The ESE 120 operates mostly independently from the GWE 112, except that via the interface, the GWE 112 may send certain entertainment game control parameters and elements to the ESE 120 to affect its play, such as (but not limited to) what level of character to be using, changing the difficulty level of the game, changing the type of gun or car in use, and/or requesting portions to become available or to be found by the character. These game control parameters and elements may be based on a gambling outcome of a gambling game that was triggered by an element in the entertainment game being acted upon by the player. The ESE 120 can accept this input from the GWE 112, make adjustments, and continue the play action all the while running seamlessly from the player's perspective. The ESE's 120 operation is mostly skill based, except for where the ESE's 120 processes may inject complexities into the game by chance in its normal operation to create unpredictability in the entertainment game. Utilizing this interface, the ESE 120 may also communicate player choices made in the game to the GWE 112, such as but not limited to selection of a different gun, and/or the player picking up a special portion in the GW environment. The GWE's 112 job in this architecture, being interfaced thusly to the ESE 120, is to allow the transparent coupling of entertainment software to a fair and transparent random chance gambling game, providing a seamless perspective to the player that they are playing a typical popular entertainment game (which is skill based). In certain embodiments, the ESE 120 can be used to enable a wide range of entertainment games including but not limited to popular titles from arcade and home video games, such as but not limited to Gears of War (a third person shooter game developed by Epic Games of Cary, N.C.), Time Crisis (a shooter arcade game developed by Namco Ltd of Tokyo, Japan), or Madden Football (an American football video game developed by EA Tiburon of Maitland, Fla.). Providers of such software can provide the previously described interface by which the GWE 120 can request amendments to the operation of the ESE 120 software in order to provide seamless and sensible operation as both a gambling game and an entertainment game.

In several embodiments, the RWE 102 can accept a trigger to run a gambling game in response to actions taken by the player in the entertainment game as conveyed by the ESE 120 to the GWE 112, or as triggered by the GWE 112 based on its algorithms, background to the overall game from the player's perspective, but can provide information to the GWE 112 to expose the player to certain aspects of the gambling game, such as (but not limited to) odds, amount of RWC in play, and amount of RWC available. The RWE 102 can accept modifications in the amount of RWC wagered on each individual gambling try, or the number of games per minute the RWE 102 can execute, entrance into a bonus round, and other factors, all the while these factors can take a different form than that of a typical slot machine. An example of a varying wager amount that the player can choose might be that they have decided to play with a more powerful character in the game, a more powerful gun, or a better car. These choices can increase or decrease the amount wagered per individual gambling game, in the same manner that a standard slot machine player may decide to wager more or less credits for each pull of the handle. In several embodiments, the RWE 102 can communicate a number of factors back and forth to the GWE 112, via an interface, such increase/decrease in wager being a function of the player's decision making as to their operational profile in the entertainment game (such as but not limited to the power of the character, gun selection or car choice). In this manner, the player is always in control of the per game wager amount, with the choice mapping to some parameter or component that is applicable to the entertainment game experience of the hybrid game. In a particular embodiment, the RWE 102 operation can be a game of chance as a gambling game running every 10 seconds where the amount wagered is communicated from the GWE 112 as a function of choices the player makes in the operation profile in the entertainment game such as those cited above.

In many embodiments, a multisession hybrid game integrates a video game style gambling machine, where the gambling game (including an RWE 102 and RWC) is not player skill based, while at the same time allows players to use their skills to earn club points which a casino operator can translate to rewards, tournament opportunities and prizes for the players. The actual exchange of monetary funds earned or lost directly from gambling against a game of chance in a gambling game, such as a slot machine, is preserved. At the same time a rich environment of rewards to stimulate gamers can be established with the entertainment game. In several embodiments, the multisession hybrid game can leverage very popular titles with gamers and provides a sea change environment for casinos to attract players with games that are more akin to the type of entertainment that a younger generation desires. In various embodiments, players can use their skill towards building and banking GWC that in turn can be used to win tournaments and various prizes as a function of their gamer prowess. Numerous embodiments minimize the underlying changes needed to the aforementioned entertainment software for the hybrid game to operate within an entertainment game construct, thus making a plethora of complex game titles and environments, rapid and inexpensive to deploy in a gambling environment.

In certain embodiments, multisession hybrid games also allow players to gain entry into subsequent competitions through the accumulation of game world credits (GWC) as a function of the user's demonstrated skill at the game. These competitions can pit individual players or groups of players against one another and/or against the casino to win prizes based upon a combination of chance and skill. These competitions may be either asynchronous events, whereby players participate at a time and/or place of their choosing, or they may be synchronized events, whereby players participate at a specific time and/or venue.

In many embodiments, one or more players engage in playing an entertainment game, resident in the ESE 120, the outcomes of which are dependent at least in part on skill. The multisession hybrid game can include an entertainment game that includes head to head play between a single player and the computer, between two or more players against one another, or multiple players playing against the computer and/or each other, as well as the process by which players bet on the outcome of the entertainment game. The entertainment game can also be a game where the player is not playing against the computer or any other player, such as in games where the player is effectively playing against himself or herself (such as but not limited to Solitaire and Babette).

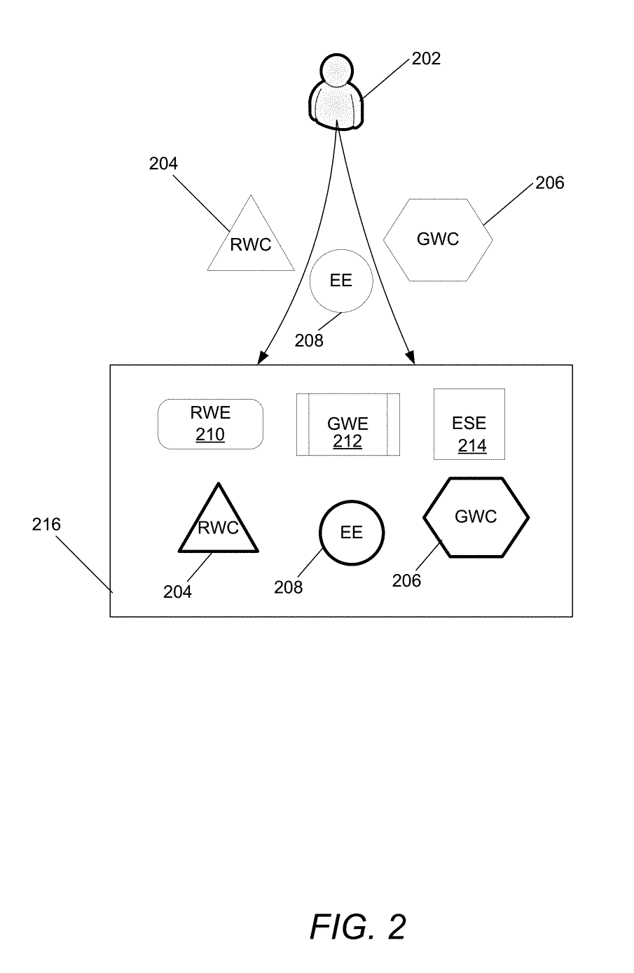

In several embodiments, a player can interact with a multisession hybrid game by using RWC in interactions with a gambling game along with GWC and elements in interactions with an entertainment game. The gambling game can be executed by a RWE while an entertainment game can be executed with an ESE and managed with a GWE. A conceptual diagram that illustrates how resources such as GWC, RWC and elements, such as but not limited to EE, are utilized in a multisession hybrid game in accordance with an embodiment of the invention is illustrated in FIG. 2. The conceptual diagram illustrates that RWC 204, EE 208 and GWC 206 can be utilized by a player 202 in interactions with the RWE 210, GWE 212 and ESE 214 of a multisession hybrid game 216. The contribution of elements, such as EE 208, may be linked to a player's access to credits, such as RWC 204 or GWC 206. Electronic transfer in of these credits may come via a smart card, voucher or other portable media, or as transferred in over a network from a server. In certain implementations, these credits may be drawn on demand from a player profile located in a database locally on a multisession hybrid game or in a remote server.

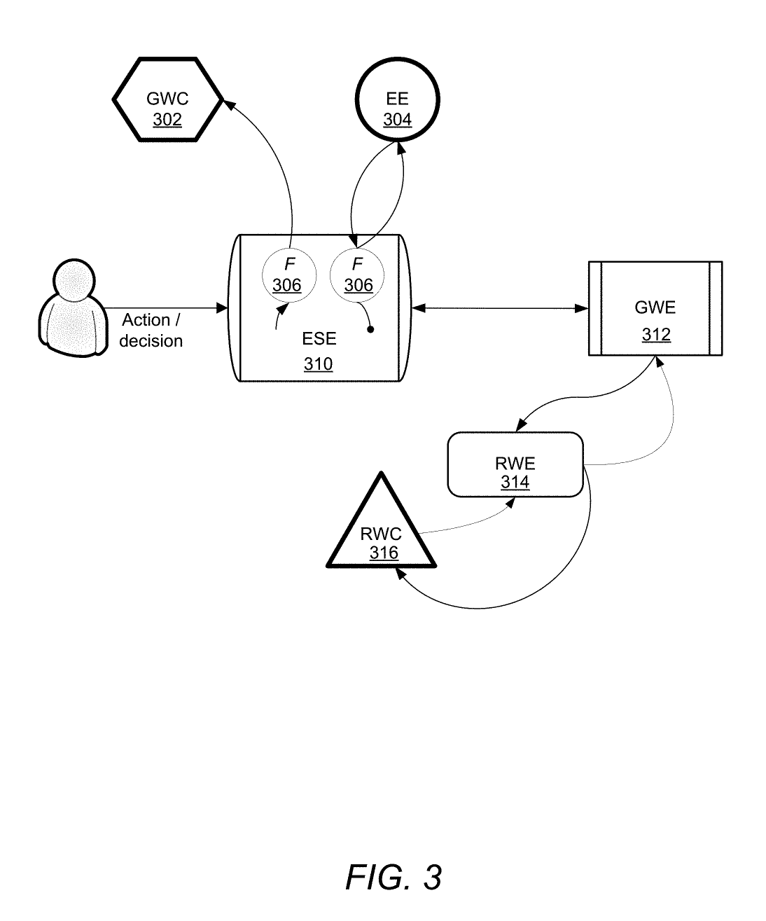

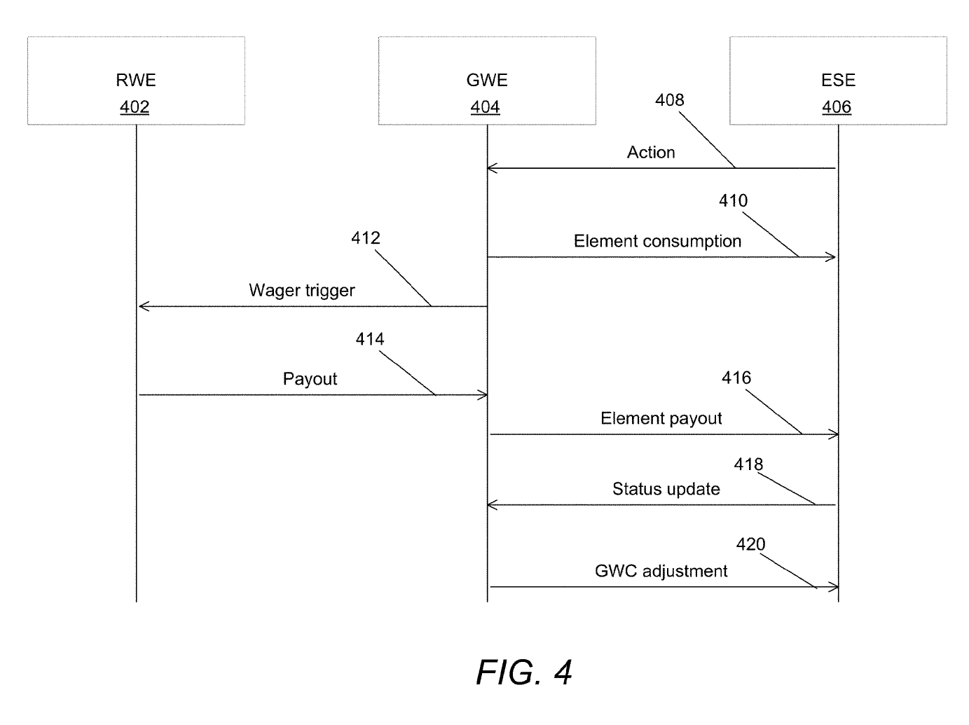

A conceptual diagram that illustrates interplay between elements and components of a multisession hybrid game in accordance with an embodiment of the invention is illustrated in FIG. 3. Similar to FIG. 2, a player's actions and/or decisions can affect functions 306 that consume and/or accumulate GWC 302 and/or EE 304 in an entertainment game executed by an ESE 310. A GWE 312 can monitor the activities taking place within an entertainment game executed by an ESE 310 for gameplay gambling event occurrences. The GWE 312 can also communicate the gameplay gambling event occurrences to an RWE 314 that triggers a wager of RWC 316 in a gambling game executed by the RWE 314. A timing diagram that illustrates a process of facilitating interactions between an entertainment game and a gambling game in accordance with embodiments of the invention is illustrated in FIG. 4. The process includes a player performing a player action using a user interface. An ESE 406 can signal (408) a GWE 404 of the player action. The GWE 404 can signal (410) the ESE 406 as to the amount of EE that will be consumed by the player action in return. The signal can configure a function that controls EE consumption, decay or addition for the ESE 406. The ESE 406 can, based upon the function, consume an amount of EE designated by the GWE 404 to couple to the activity. Upon detection that the player action is a gameplay gambling event, the GWE 404 can signal an RWE 402 as to the wager terms associated with the gameplay gambling event triggers (412) a wager. The RWE 402 can consume RWC in executing the wager. The RWE 402 can return RWC as a payout from the wager. The RWE 402 can inform (414) the GWE 404 as to the payout from the wager. The GWE 404 can signal (416) the ESE 406 to ascribe a payout of EE based upon the wager. The ESE 406 can reconcile and combine the payout of EE with the EE already ascribed to the player in the entertainment game. The ESE 406 can signal (408) the GWE 404 as to its updated status based upon reconciling the payout of EE, and the GWE 404 can signal the ESE 406 of a payout of GWC in response (420) to the status update.

In certain embodiments, the sequence of events in the timing diagram of FIG. 4 can be reflected in a first person shooter themed entertainment game. For example, a player can select a machine gun to use in an entertainment game and fires a burst at an opponent. The ESE 406 can signal (408) the GWE 404 of the player action, such as the player's choice of weapon, that a burst of fire was fired, and the outcome of whether the player hit the opponent with the burst of fire. The GWE 404 can process the information concerning the machine gun burst, and signal (410) the ESE 406 to consume 3 bullets (EE) with each pull of the trigger. The entertainment game then will consumes 3 bullets (EE) from the trigger being pulled. The GWE 404 can also signal (412) the RWE 402 that 3 credits of RWC are to be wagered to match the 3 bullets (EE) consumed, on a particular pay table (Table Ln-RC) as a function how much damage the player inflicted on his/her opponent. The RWE 402 can consume the 3 credits for the wager and execute the specified wager. In executing the wager, the RWE 402 can determine that the player hits a jackpot of 6 credits, and return the 6 credits of RWC to the credit meter. The RWE 402 can also inform (414) the GWE 404 that 3 credits of RWC net were won as a payout from the wager. The GWE 404 can signal (416) the ESE to add 3 bullets (EE) to the player's ammo clip based upon the gambling game payout. The ESE 406 can then add 3 bullets (EE) to the player's ammo clip in the entertainment game. This may take place by directly adding them to the clip, or may happen in the context of the entertainment game, such as the player finding extra ammo on the ground or in an old abandoned ammo dump. The GWE 404 can receive an update (418) from the ESE 406 as to the total amount of EE associated with the player. The GWE 404 can log the new player score (GWC) in the game (as a function of the successful hit on the opponent) based on the update, and signal (420) the ESE 406 to add 2 extra points of GWC to the player's score.

In many embodiments, if an entertainment game includes a version of Madden Football™ a player can bet on whether or not the player is going to beat the computer, or if the player is playing against another player, that other player. These bets can be made, for example, on the final outcome of the game, and/or the state of the game along various intermediary points (such as but not limited to the score at the end of the 1st quarter) and/or on various measures associated with the game (such as but not limited to the total offensive yards, number of turnovers, or number of sacks). Players can bet against one another, or engage the computer in a head to head competition in the context of their skill level in the entertainment game in question. As such, players can have a handicap associated with their player profile that describes their skill (which can be their professed skill in certain embodiments), and which is used by a GWE (such as a local GWE or a GWE that receives services from remote servers) to offer appropriate bets around the final and/or intermediate outcomes of the entertainment game, and/or to condition sponsored gameplay as a function of player skill, and/or to select players across one or more multisession hybrid games to participate in head to head games and/or tournaments.

Many embodiments enable the maximization of the number of players able to compete competitively by enabling handicapping of players by utilizing a skill normalization module that handicaps players to even the skill level of players competing against each other. Handicapping enables players of varying performance potential to compete competitively regardless of absolute skill level, such as but not limited to where a player whose skill level identifies the player as a beginner can compete in head to head or tournament play against a highly skilled player with meaningful results.

In several embodiments, wagers can be made among numerous multisession hybrid games with a global betting manager (GBM). The GBM is a system that coordinates wagers that are made across multiple multisession hybrid games by multiple players. In some implementations it can also support wagers by third parties relative to the in game performance of other players. The GBM can stand alone, or is capable of being embedded in one of a number of systems, including a GWE, ESE or any remote server capable of providing services to a multisession hybrid game, or can operate independently on one or a number of servers on-site at a casino, as part of a larger network and/or the internet or cloud in general. The GBM also supports the management of lottery tickets issued as a function of sponsored gameplay.

Although various components of multisession hybrid games are discussed above, multisession hybrid games can be configured with any component as appropriate to the requirements of a specific application in accordance with embodiments of the invention. In certain embodiments, components of a multisession hybrid game, such as a GWE, RWE, ESE can be networked in different configurations for a specific multisession hybrid game gameplay application. Network connected multisession hybrid games are discussed below.

### Network Connected Multisession Hybrid Games

Multisession hybrid games in accordance with many embodiments of the invention can operate locally while being network connected to draw services from remote locations or to communicate with other multisession hybrid games. In many embodiments, operations associated with a multisession hybrid game utilizing a multisession module can be performed across multiple devices. These multiple devices can be implemented using a single server or a plurality of servers such that a multisession hybrid game is executed as a system in a virtualized space, such as (but not limited to) where the RWE and GWE are large scale centralized servers in the cloud coupled to a plurality of widely distributed ESE controllers or clients via the Internet.

In many embodiments, an RWE server can perform certain functionalities of a RWE of a multisession hybrid game. In certain embodiments, a RWE server includes a centralized odds engine which can generate random outcomes (such as but not limited to win/loss outcomes) for a gambling game, thereby eliminating the need to have that functionality of the RWE performed locally within the multisession hybrid game. The RWE server can perform a number of simultaneous or pseudo-simultaneous runs in order to generate random outcomes for a variety of odds percentages that one or more networked multisession hybrid games may require. In certain embodiments, an RWE of a multisession hybrid game can send information to a RWE server including (but not limited to) Table Ln-RWC tables, maximum speed of play for a gambling game, gambling game monetary denominations or any promotional RWC provided by the operator of the multisession hybrid game. In particular embodiments, a RWE server can send information to a RWE of a multisession hybrid game including (but not limited to) RWC used in the gambling game, player profile information or play activity and a profile associated with a player.

In several embodiments, a GWE server can perform the functionality of the GWE across various multisession hybrid games. These functionalities can include (but are not limited to) providing a method for monitoring high scores on select groups of games, coordinating interactions between gameplay layers, linking groups of games in order to join them in head to head tournaments, and acting as a tournament manager.

In a variety of embodiments, management of player profile information can be performed by a patron management server separate from a GWE server. A patron management server can manage information related to a player profile, including (but not limited to) data concerning controlled entities (such as characters used by a layer in entertainment game gameplay), game scores, elements, RWC and GWC associated with particular players and managing tournament reservations. Although a patron management server is discussed separate from a GWE server, in certain embodiments a GWE server also performs the functions of a patron management server. In certain embodiments, a GWE of a multisession hybrid game can send information to a patron management server including (but not limited to) GWC and RWC used in a game, player profile information, play activity and profile information for players and synchronization information between a gambling game and an entertainment game or other aspects of a multisession hybrid game. In particular embodiments, a patron management server can send information to a GWE of a multisession hybrid game including (but not limited to) entertainment game title and type, tournament information, Table Ln-GWC tables, special offers, character or profile setup and synchronization information between a gambling game and an entertainment game or other aspects of a multisession hybrid game.

In numerous embodiments, an ESE server provides a host for managing head to head play, operating on the network of ESEs which are connected to the ESE server by providing an environment where players can compete directly with one another and interact with other players. Although an ESE server is discussed separate from a GWE server, in certain embodiments a GWE server also performs the functions of an ESE server.

In several embodiments, a multisession server can be connected with a multisession hybrid game and can implement a multisession module to coordinate the activities of a multisession hybrid game. A multisession module can execute as part of a multisession server to enable multisession entertainment game gameplay that is continuous across multiple gameplay sessions. The multisession module is configured to enable multisession entertainment game gameplay by initiating a current entertainment game gameplay session for a player that builds upon the player's interactions with a multisession hybrid game in a prior entertainment game gameplay session.

Servers connected via a network to implement multisession hybrid games in accordance with many embodiments of the invention can communicate with each other to provide services utilized within a multisession hybrid game. In several embodiments a RWE server can communicate with a GWE server. A RWE server can communicate with a GWE server to communicate any type of information as appropriate for a specific application, including (but not limited to): configure the various simultaneous or pseudo simultaneous odds engines executing in parallel within the RWE to accomplish the multisession hybrid game system requirements, determine metrics of RWE performance such as random executions run and outcomes for tracking system performance, perform audits, provide operator reports, and request the results of a random run win/loss result for use of function operating within the GWE (such as where automatic drawings for prizes are a function of ESE performance).

In several embodiments a GWE server can communicate with an ESE server. A GWE server can communicate with an ESE server to communicate any type of information as appropriate for a specific application, including (but not limited to): the management of an ESE server by a GWE server such as the management of a multisession hybrid game tournament. Typically a GWE (such as a GWE that runs within a multisession hybrid game or on a GWE server) is not aware of the relationship of itself to the rest of a tournament since in a typical configuration the actual tournament play is managed by the ESE server. Therefore, management of a multisession hybrid game tournament can include (but is not limited to) tasks such as: conducting tournaments according to system programming that can be coordinated by an operator of the multisession hybrid game; allowing entry of a particular player into a tournament; communicating the number of players in a tournament and the status of the tournament (such as but not limited to the amount of surviving players, their status within the game, time remaining on the tournament); communicating the status of an ESE contained in a game; communicating the performance of its players within the tournament; communicating the scores of the various members in the tournament; and providing a synchronizing link to connect the GWEs in a tournament, with their respective ESE's.

In several embodiments a GWE server can communicate with a patron management server. A GWE server can communicate with a patron server to communicate any type of information as appropriate for a specific application, including (but not limited to) information for configuring tournaments according to system programming conducted by an operator of a multisession hybrid game, exchange of data necessary to link a player's player profile to their ability to participate in various forms of sponsored gameplay (such as but not limited to the difficulty of play set by the GWE server or the GWE in the game they are playing on), determining a player's ability to participate in a tournament as a function of a player's characteristics (such as but not limited to a player's gaming prowess or other metrics used for tournament screening), configuring the game contained GWE and ESE performance to suit preferences of a player on a particular multisession hybrid game, as recorded in their player profile, determining a player's play and gambling performance for the purposes of marketing intelligence, and logging secondary drawing awards, tournament prizes, RWC and GWC into the player profile.

In many embodiments, the actual location of where various algorithms and functions are executed may be located either in the game contained devices (RWE, GWE, ESE), on the servers (RWE server, GWE server, or ESE server), or a combination of both. In particular embodiments, certain functions of a RWE server, GWE server, patron management server or ESE server may operate on the local RWE, GWE or ESE contained with a multisession hybrid game locally. In certain embodiments, a server is a server system including a plurality of servers, where software may be run on one or more physical devices. Similarly, in particular embodiments, multiple servers may be combined on a single physical device.

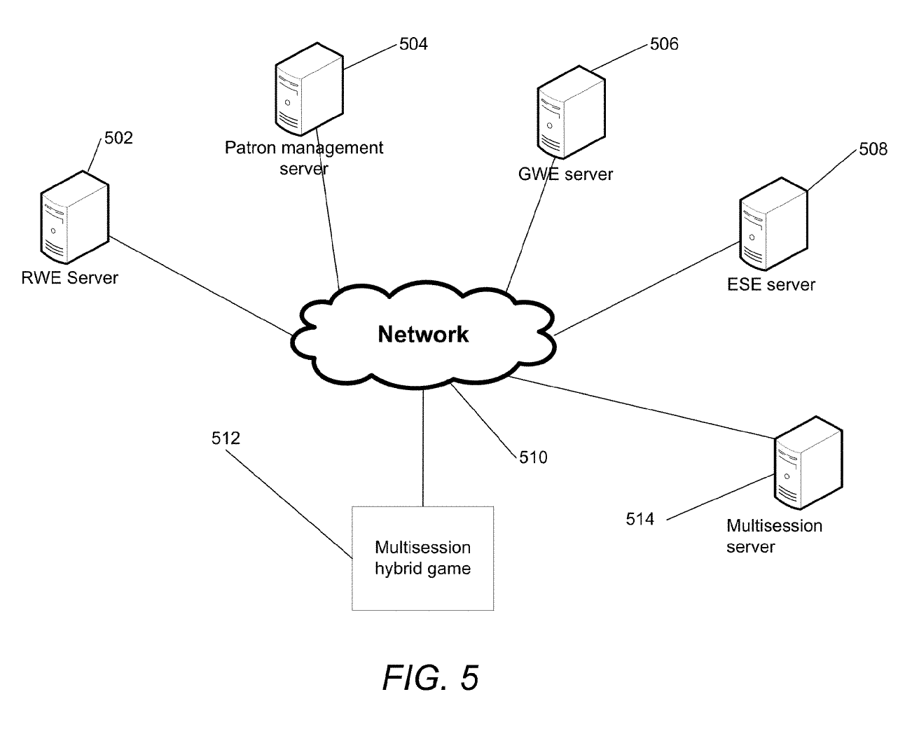

Multisession hybrid games in accordance with many embodiments of the invention can be networked with remote servers in various configurations. A networked multisession hybrid game in accordance with an embodiment of the invention is illustrated in FIG. 5. The networked multisession hybrid game 512 is connected with a RWE server 502, patron management server 504, GWE server 506, ESE server 508 and a multisession server 514 over a network 510, such as (but not limited to) the Internet. Servers networked with a networked multisession hybrid game 512 can also communicate with each of the components of a networked multisession hybrid game and amongst the other servers in communication with the networked multisession hybrid game 512.

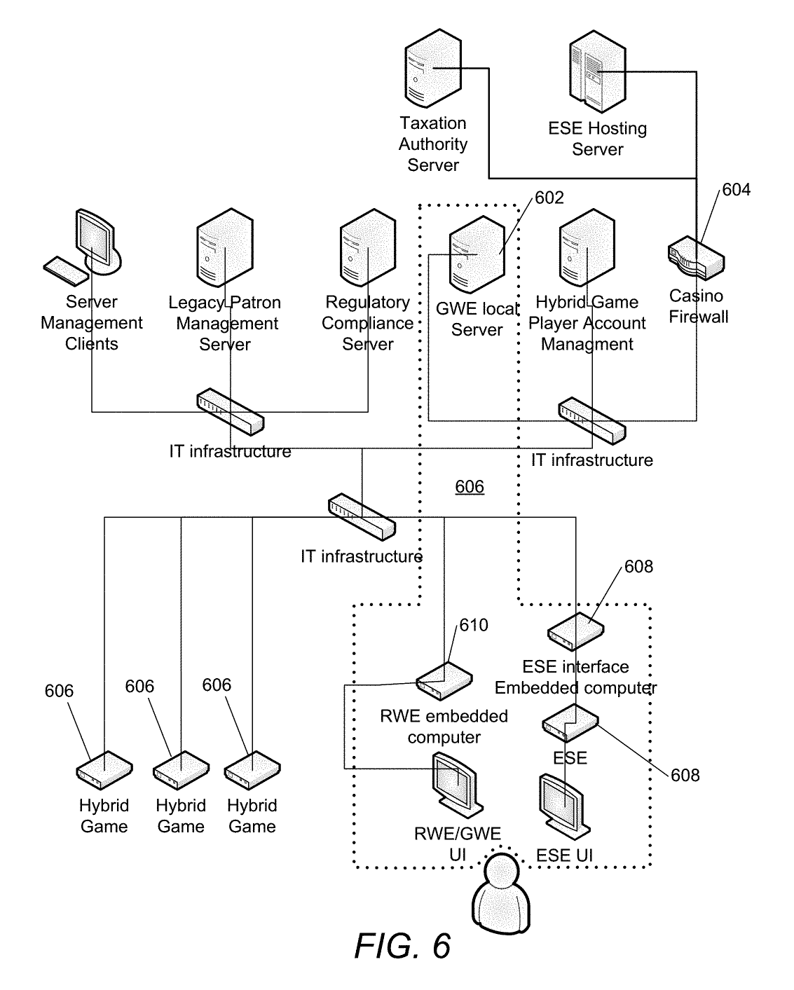

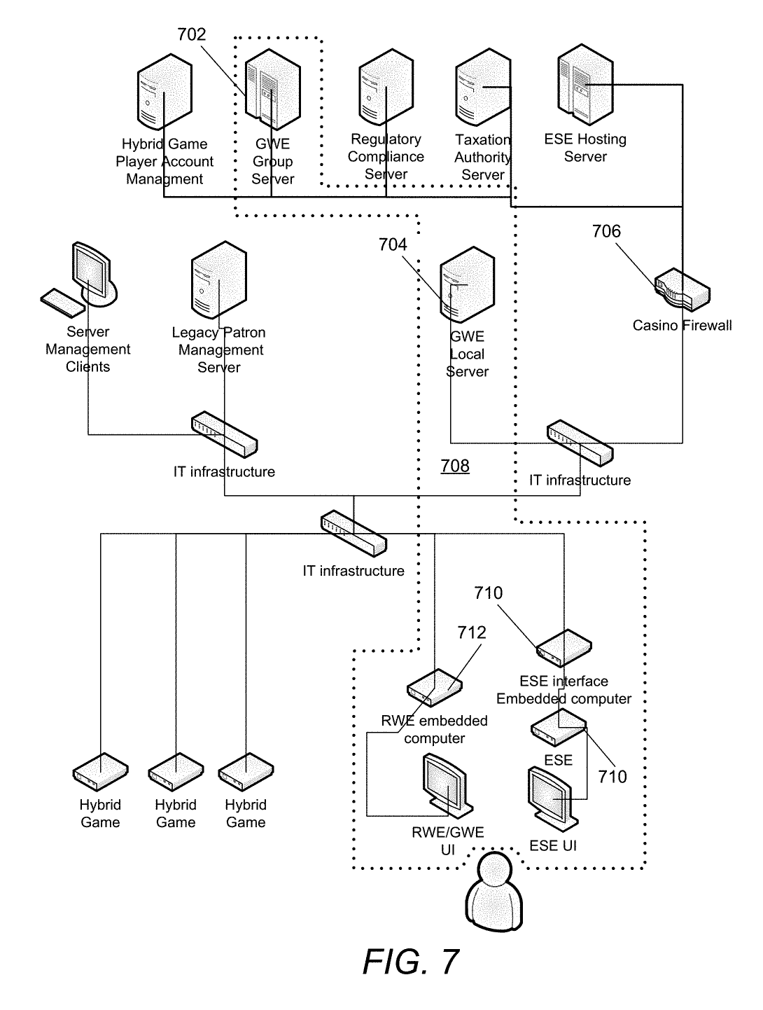

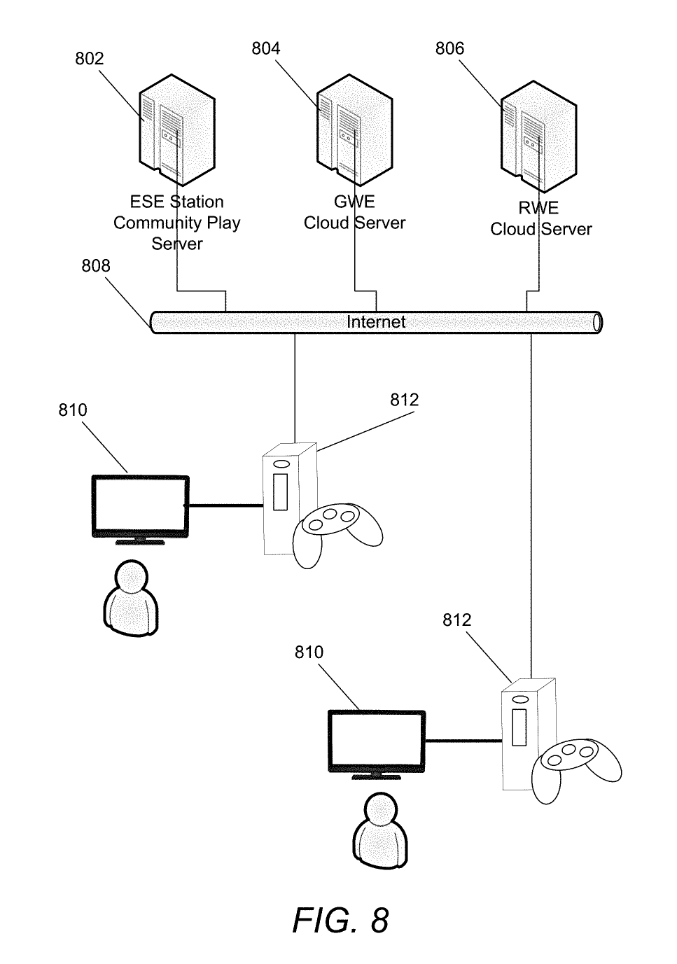

A system diagram that illustrates an implementation of a network distributed multisession hybrid game with a GWE local server in accordance with an embodiment of the invention is illustrated in FIG. 6. The system includes several multisession hybrid games 606 sharing services from the same GWE local server 602 over a network. A single multisession hybrid game 606 with a RWE 610, ESE 608 and GWE 602 is enclosed within a dotted line. A number of other peripheral systems, such as player management, casino management, regulatory, and hosting servers can also interface with the multisession hybrid games over a network within an operator's firewall 604. Also, other servers can reside outside the bounds of a network within an operator's firewall 604 to provide additional services for network connected multisession hybrid games. A system diagram that illustrates an implementation of a network distributed hybrid game with a GWE local server and a GWE group server in accordance with an embodiment of the invention is illustrated in FIG. 7. This system includes a multisession hybrid game with a RWE 712, ESE 710 and GWE 704 enclosed within a dotted line but where a single hybrid game can call upon services from servers within an operator's firewall 706 (such as but not limited to a GWE local server) as well as beyond an operator's firewall 706 (such but not limited to a GWE group server 702). The GWE group server 702 can coordinate multiple multisession hybrid games from across a network that spans beyond an operator's firewall 706. A system diagram that illustrates an implementation of network distributed hybrid games over the Internet in accordance with an embodiment of the invention is illustrated in FIG. 8. The system includes an ESE server 802, GWE server 804 and RWE server 806 that connects to a user interface 810 of multisession hybrid games over the Internet 808. Each multisession hybrid game includes a local ESE 812 that also interfaces with a remote ESE server 802.

Although various networked multisession hybrid games are discussed above, multisession hybrid games can be networked in any configuration as appropriate to the requirements of a specific application in accordance with embodiments of the invention. In certain embodiments, components of a networked multisession hybrid game, such as a GWE, RWE, ESE or servers that perform services for a GWE, RWE or ESE, can be networked in different configurations for a specific networked multisession hybrid game gameplay application. Multisession modules are discussed below.

### Multisession Modules

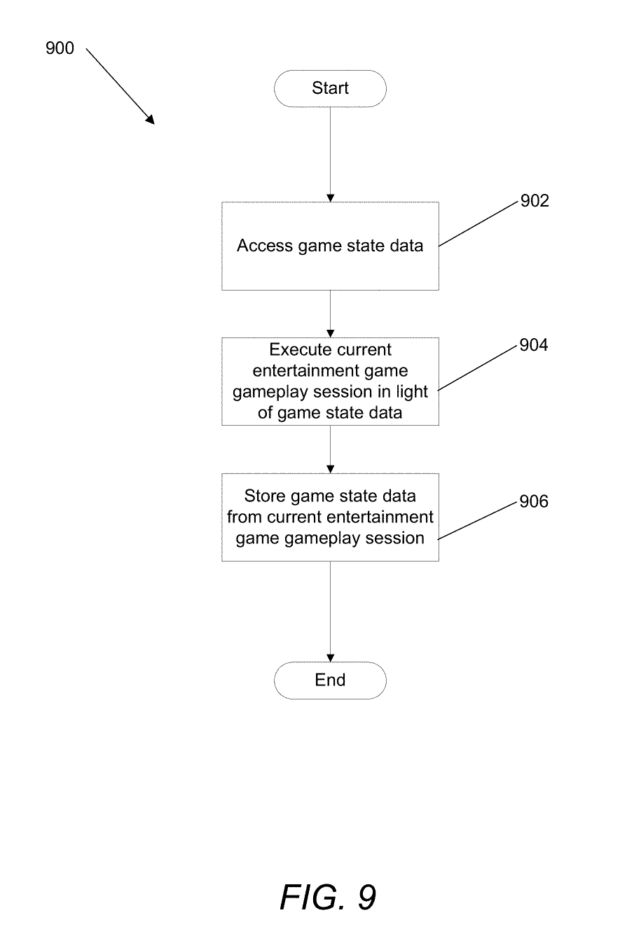

A multisession module in accordance with many embodiments of the invention enables a player to progress in multisession entertainment game gameplay with a continuous experience across several entertainment game gameplay sessions. The multisession module is configured to enable multisession entertainment game gameplay by initiating a current entertainment game gameplay session for a player that builds upon the player's interactions with a multisession hybrid game in a prior entertainment game gameplay session. A database can be utilized to store game state data for use by the multisession module. The database can be located locally within a multisession hybrid game or on a remote server accessible to a multisession hybrid game over a network. The database can be queried to retrieve and store game state data in accordance with a game state data identifier that identifies the game state data. In certain embodiments, the game state data is associated with a player profile of a player. The game state data identifier can be identifying characteristics unique to a player, such as a player's name or a name given to game state data associated with a particular entertainment game gameplay session. A flow chart of a process of executing a multisession entertainment game gameplay session in accordance with an embodiment of the invention is illustrated in FIG. 9. The process 900 includes accessing (902) game state data stored within a database. The game state data can be accessed as retrieved from a database using a game state data identifier that identifies the game state data. The game state data can then be utilized (904) in configuring a current entertainment game gameplay session. The game state data can concern a player's progress in a previous entertainment game gameplay session such that the current entertainment game gameplay session is initiated in a way that builds upon the player's interactions in the previous entertainment game gameplay session. Game state data from the current entertainment game gameplay session can also be stored (906) within the database and retrieved for use in configuring a future entertainment game gameplay session that builds upon the player's interactions with the current entertainment game gameplay session.

In several embodiments, game state data can be stored in a first multisession hybrid game and retrieved by a second multisession hybrid game over a network by copying the game state data from the first multisession hybrid game to the second multisession hybrid game. Alternatively, game state data can be stored in a centralized location, such as in a centralized server, and retrieved by copying the game state data from the centralized server to a multisession hybrid game over a network.

In numerous embodiments, game state data includes information that can be used to configure a current entertainment game gameplay session for a player that builds upon the player's interactions with a multisession hybrid game in a prior entertainment game gameplay session. Game state data can include information such as but not limited to a player's nickname, rating for skill at an entertainment game, preferences for a gameplay session, entertainment game theme preferences, a last game level achieved at an entertainment game, accumulation of game world credits, a preferred starting point in the entertainment game, a selected avatar, sound volume, wager term preferences, elements accrued, and real world credits used for wagering.

In several embodiments, a game state data identifier can be utilized to identify and retrieve game state data used to initiate a current entertainment game gameplay session. A game state identifier can be any information utilized to identify, retrieve or store game state data including but not limited to a unique code. In certain embodiments, a code utilized to query and retrieve game state data is utilized upon a detection of biometric information. In several embodiments, a game state data identifier is a code printed on a ticket when an entertainment game gameplay session concludes that identifies game state data generated from the entertainment game gameplay session.

In numerous embodiments, a game state data identifier can be unique to a particular entertainment game gameplay session or can identify a set of multiple entertainment game gameplay sessions associated with a particular player or group of players. In several embodiments, the code can be any symbol or form that can be utilized to identify game state data such as but not limited to a barcode, numeric code, alphabetic code, alphanumeric code or quick response (QR) code.

In a number of embodiments, a game state data identifier can be utilized to retrieve game state data upon detection of biometric information associated with a player. Biometric information can include the detection of physical information used to identify a player such as but not limited to a retinal scans, iris recognition, fingerprints, palm prints, facial/image recognition, and voice prints. In certain embodiments, biometric information can be recorded that is associated with a player upon the conclusion of an entertainment game gameplay session.

In several embodiments, a multisession module can be utilized as part of a host mode that operates on a multisession hybrid game to provide a personalized user interface for players. Using a host mode, players can access information useful to the player in personalizing the multisession hybrid game with personalized aspects of the multisession hybrid game stored in a player profile. A player can personalize a multisession hybrid game in various ways, such as (but not limited to) setting the difficulty setting at which the entertainment game is performing, determining the conversions among elements, RWC and GWC, setting entertainment game play time or goals to be reached during gameplay, setting up a player account or settings for interactions with a virtual community. Various configurations for a host mode utilizable by multisession hybrid games are discussed in U.S. Provisional Patent Application Nos. 61/572,135, filed Jul. 12, 2011, and 61/629,018, filed Nov. 10, 2011, and in Patent Cooperation Treaty Application No. PCT/US12/46441, filed Jul. 12, 2012, the contents of each of which are hereby incorporated by reference in its entirety as if stated in full herein.

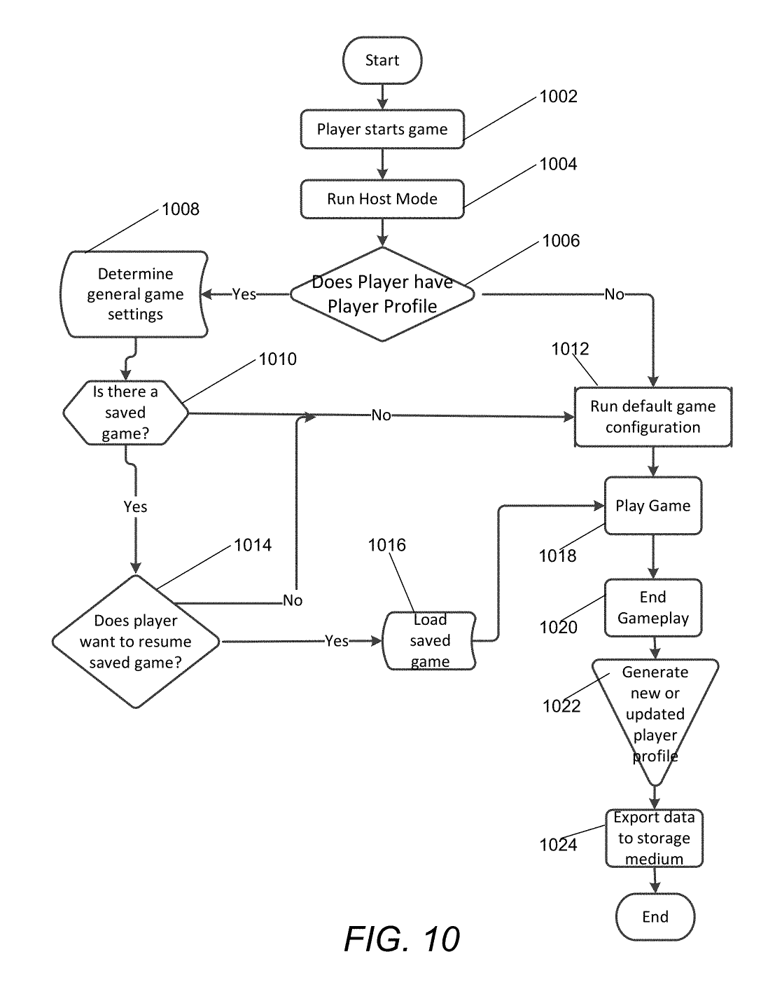

In several embodiments, a host mode can interface with a multisession module to initiate a current entertainment game gameplay session for a player that builds upon the player's interactions with a multisession hybrid game in a prior entertainment game gameplay session. The host mode can be utilized to store game state data associated with a player in a personalized player profile. A player can then initiate a host mode which accesses the player profile to retrieve saved game state data. A flow chart of a process of executing a multisession hybrid game gameplay session utilizing host mode in accordance with an embodiment of the invention is illustrated in FIG. 10. The process includes a player initializing (1002) a multisession hybrid game. The multisession hybrid game can then run (1004) a host mode. The host mode can make a determination (1006) as to whether the player has an associated player profile accessible to the multisession hybrid game. If the player has a player profile, then the host mode will utilize a multisession module to retrieve (1008) general game state data for the multisession hybrid game from the player profile, such as but not limited to any settings or parameters for a multisession hybrid game personalized to a player. If the player does not have a player profile, then the host mode will generate (1012) a default configuration for a current entertainment game gameplay session and the player can begin (1018) the current entertainment game gameplay session with the default configuration. A default game configuration can be a standard configuration for new players of the entertainment game or can be a configuration selected by a player during a current entertainment game gameplay session. A determination (1010) can be made as to whether there is specific game state data from a particular entertainment game gameplay session associated with the player profile. If there is no game state data from a particular entertainment game gameplay session, then a default configuration for an entertainment game gameplay session is generated (1012) and the player can begin (1018) the current entertainment game gameplay session with the default configuration. If there is game state data from a particular entertainment game gameplay session, then a determination (1014) is made as to whether the player desires to resume a saved game from the game state data associated with a particular entertainment game gameplay session. If a player indicates a desire to not resume a saved game, then a default game configuration is generated (1012) and a player can begin (1018) a current entertainment game gameplay session with the default game configuration. If a player indicates a desire to resume a saved game, then game state data from a previous entertainment game gameplay session is loaded (1016) and utilized in configuring a current entertainment game gameplay session and a player can begin (1018) the current entertainment game gameplay session. Upon ending (1020) the current entertainment game gameplay session, a new and/or updated player profile can be generated (1022) with game state data and exported (1024) into a storage medium.

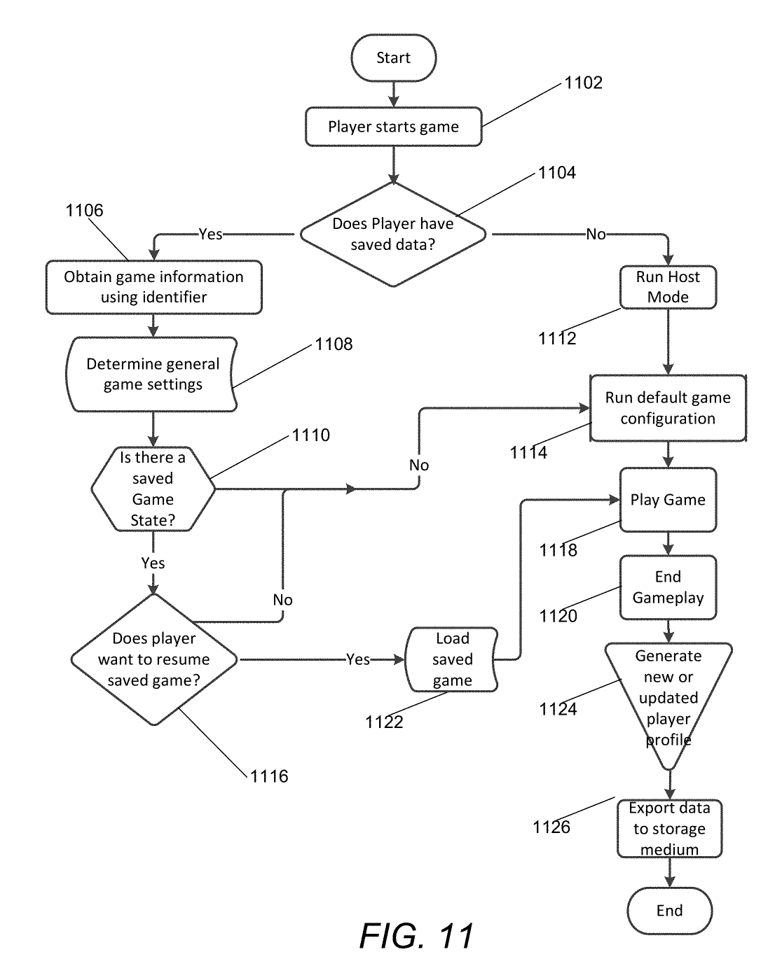

A flow chart of a process of executing a multisession hybrid game gameplay session utilizing game state data identifiers in accordance with an embodiment of the invention is illustrated in FIG. 11. The process includes a player initializing (1102) a multisession hybrid game. A determination (1104) can be made as to whether the player has stored game state data associated with the player. In certain embodiments, this determination can be made manually, such as by player indicating that there is stored game state data. If the player has stored game state data associated with the player, then a multisession module can use (1106) a game state data identifier to retrieve (1108) general game state data for the multisession hybrid game from the player profile. In certain embodiments, the game state data identifier can be provided by a player in response to a prompt for the game state data identifier. The general game state data can include but is not limited to any settings or parameters set on account of the player and stored in the player profile. If the player does not have game state data associated with the player, then a host mode can be initiated (1112) to run a current entertainment game gameplay session with a default configuration. A default game configuration can be a standard configuration for new players of the entertainment game or can be a configuration selected by a player during a current entertainment game gameplay session. A determination (1110) can be made as to whether there is specific game state data from a particular entertainment game gameplay session after general game state data is retrieved. If there is no game state data from a particular entertainment game gameplay session, then a default configuration for an entertainment game gameplay session is generated (1114) and a player can begin (1118) the current entertainment game gameplay session with the default configuration. If there is game state data from a particular entertainment game gameplay session, then a determination (1116) is made as to whether the player elects to resume a saved game by beginning a current entertainment game gameplay session using the game state data from a particular entertainment game gameplay session. If a player indicates a desire to not resume a saved game, then a default game configuration is generated (1114) and a player can begin the current entertainment game gameplay session with the default game configuration. If a player indicates a desire to resume a saved game, then game state data from a previous entertainment game gameplay session is loaded (1122) and utilized in configuring a current entertainment game gameplay session and a player can begin (1118) the current entertainment game gameplay session. Upon ending (1120) the current entertainment game gameplay session, a new and/or updated player profile can be generated (1124) with game state data and exported (1126) into a storage medium.

Although various constructions of multisession modules are discussed above, multisession modules can be constructed to facilitate multisession entertainment game gameplay as appropriate to the requirements of a specific application in accordance with embodiments of the invention. In certain embodiments, multisession modules can store, retrieve and identify game state data in various different ways for initiation of a current entertainment game gameplay session. A discussion of a processing apparatus that can be implemented in a transportable variables hybrid game is discussed below.

### Processing Apparatus

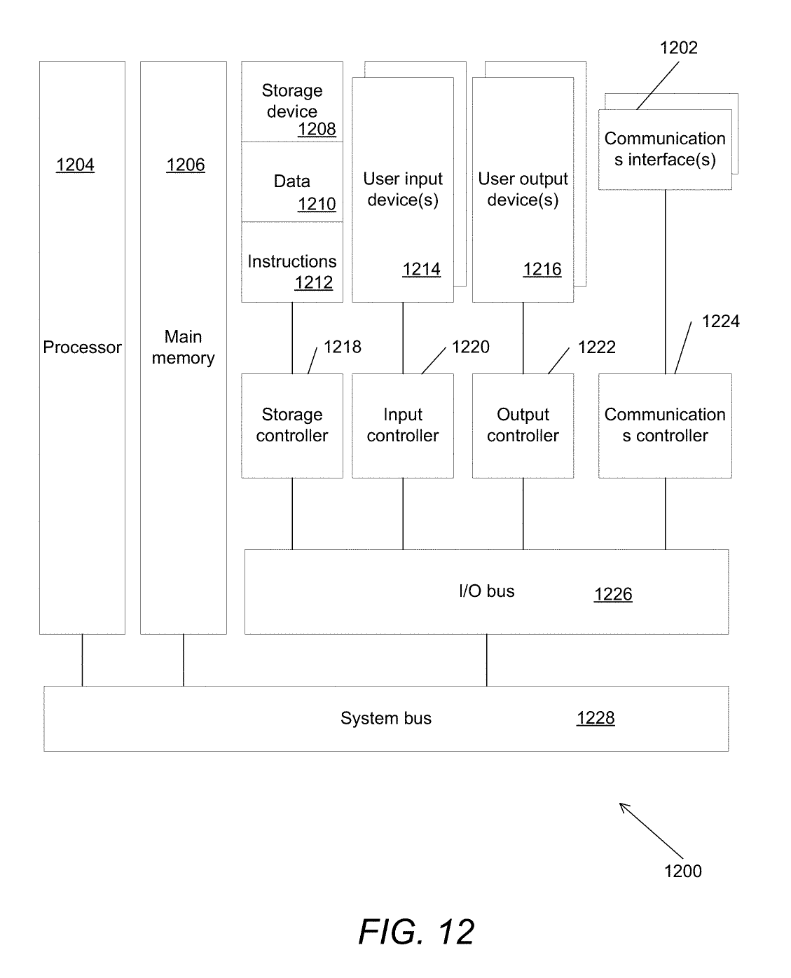

Any of a variety of processing apparatuses can host various components of a multisession hybrid game in accordance with embodiments of the invention. In several embodiments, these processing apparatuses can include, but are not limited to, a gaming machine, a general purpose computer, a computing device and/or a controller. A processing apparatus that is constructed to implement a multisession hybrid game in accordance with an embodiment of the invention is illustrated in FIG. 12. In the processing apparatus 1200, a processor 1204 is coupled to a memory 1206 by a bus 1228. The processor 1204 is also coupled to non-transitory processor-readable storage media, such as a storage device 1208 that stores processor-executable instructions 1212 and data 1210 through the system bus 1228 to an I/O bus 1226 through a storage controller 1218. The processor 1204 is also coupled to one or more interfaces that may be used to connect the processor to other processing apparatuses as well as networks as described herein. The processor 1204 is also coupled via the bus to user input devices 1214, such as tactile devices including but not limited to keyboards, keypads, foot pads, touch screens, and/or trackballs, as well as non-contact devices such as audio input devices, motion sensors and motion capture devices that the processing apparatus may use to receive inputs from a user when the user interacts with the processing apparatus. The processor 1204 is connected to these user input devices 1214 through the system bus 1228, to the I/O bus 1226 and through the input controller 1220. The processor 1204 is also coupled via the bus to user output devices 1216 such as (but not limited to) visual output devices, audio output devices, and/or tactile output devices that the processing apparatus uses to generate outputs perceivable by the user when the user interacts with the processing apparatus. In several embodiments, the processor is coupled to visual output devices such as (but not limited to) display screens, light panels, and/or lighted displays. In a number of embodiments, the processor is coupled to audio output devices such as (but not limited to) speakers, and/or sound amplifiers. In many embodiments, the processor is coupled to tactile output devices like vibrators, and/or manipulators. The processor is connected to output devices from the system bus 1228 to the I/O bus 1226 and through the output controller 1222. The processor 1204 can also be connected to a communications interface 1202 from the system bus 1228 to the I/O bus 1226 through a communications controller 1224.

In various embodiments, a processor loads the instructions and the data from the storage device into the memory and executes the instructions and operates on the data to implement the various aspects and features of the components of a gaming system as described herein. The processor uses the user input devices and the user output devices in accordance with the instructions and the data in order to create and operate user interfaces for players, casino operators, and/or owners as described herein.

Although the processing apparatus is described herein as being constructed from a processor and instructions stored and executed by hardware components, the processing apparatus can be composed of only hardware components in accordance with many embodiments. In addition, although the storage device is described as being coupled to the processor through a bus, those skilled in the art of processing apparatuses will understand that the storage device can include removable media such as but not limited to a USB memory device, an optical CD ROM, magnetic media such as tape and disks. Also, the storage device can be accessed through one of the interfaces or over a network. Furthermore, any of the user input devices or user output devices can be coupled to the processor via one of the interfaces or over a network. In addition, although a single processor is described, those skilled in the art will understand that the processor can be a controller or other computing device or a separate computer as well as be composed of multiple processors or computing devices.

In numerous embodiments, any of an RWE, GWE or ESE as described herein can be implemented on multiple processing apparatuses, whether dedicated, shared or distributed in any combination thereof, or may be implemented on a single processing apparatus. In addition, while certain aspects and features of element management processes described herein have been attributed to an RWE, GWE, or ESE, these aspects and features may be implemented in a hybrid form where any of the features or aspects may be performed by any of a RWE, GWE, ESE within a multisession hybrid game without deviating from the spirit of the invention.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. An electromechanical game machine for providing a multisession hybrid game, the electromechanical game machine comprising:
a real world controller connected to a game world controller, the real world controller comprising:
a credit meter;
a random number generator; and
a credit paytable, wherein the real world controller is constructed to:
receive credit;
receive, from the game world controller, a wager trigger; and
determine a gambling outcome for a wager of credit using the random number generator and the credit paytable in accordance with a gambling proposition of the gambling game using the trigger;
an entertainment software controller constructed to generate a visual display for an entertainment game providing outcomes based upon skillful execution of the entertainment game to earn a payout of game world credits; and
the game world controller constructed to manage the entertainment software controller and communicate the wager trigger based upon skillful execution of the entertainment game;
wherein the game world controller utilizes a multisession module constructed to: use a first game state data identifier printed on a first ticket to load first game state data from a database accessible to the multisession module, where the first game state data is information from a prior gameplay session associated with a player and capable of being utilized to configure a current gameplay session, wherein the first game state data identifier identifies the first game state data in the database, and wherein the first game state data comprises a first entertainment game level achieved by the player, a first accumulation of game world credits and a first accumulation of game world elements accumulated by the player in the entertainment game, and first credits used in the gambling game during the prior gameplay session;
initiate the current gameplay session for the player using the first game state data retrieved by the multisession module, where the current gameplay session builds upon the player's interactions with the multisession hybrid game in the prior entertainment game gameplay session;
store second game state data in the database using a second game state data identifier based upon information concerning the current gameplay session associated with the player, wherein where the second game state data identifier identifies the second game state data in the database, and wherein the second game state data comprises a second entertainment game level achieved by the player, a second accumulation of game world credits and a second accumulation of game world elements accumulated in the entertainment game, and second credits used in the gambling game during the current gameplay session; and
print the second game state data identifier on a second ticket.

2. The electromechanical game machine of claim 1, wherein the first game state data identifier is utilized upon detection of biometric information.

3. The electromechanical game machine of claim 1, wherein the multisession module is further constructed to load the first game state data from a player profile.

4. The electromechanical game machine of claim 1, wherein the first game state data is loaded from a location accessible to the multisession hybrid game via a network.

5. The electromechanical game machine of claim 4, wherein the first game state data is loaded from a remote server and copied from memory located in the remote server to the multisession hybrid game.

6. The electromechanical game machine of claim 4, wherein the prior gameplay session is a head to head gameplay session.

7. The electromechanical game machine of claim 1, wherein the current gameplay session is executed by the entertainment software controller.

8. The electromechanical game machine of claim 1, wherein the information concerning the current gameplay session is received by the multisession module from the entertainment software controller.

9. The electromechanical game machine of claim 1, wherein the multisession module initiates the current gameplay session by communicating the game state data loaded by the multisession module to the entertainment software controller.

10. The electromechanical game machine of claim 1, wherein the player of the multisession hybrid game is an electronic representation of interactions associated with a player profile of the multisession hybrid game.

11. The multisession hybrid game of claim 1, wherein the multisession module is constructed to execute on the game world controller.

12. The electromechanical game machine of claim 1, wherein the multisession module is constructed to execute on a multisession server and communicate with the game world controller via a network.

13. The electromechanical game machine of claim 1, wherein the second game state data is generated by the multisession module.

14. The electromechanical game machine of claim 1 wherein the credit is a currency fungible instrument.

15. The electromechanical game machine of claim 1 wherein the credit is a game world credit.

16. The electromechanical game machine of claim 1, wherein the game world controller and the real world controller are constructed from the same device.
